(19) United States
(12) Patent Application Publication
(10) Pub. No.: US 2005/0130811 A1
(43) Pub. Date: Jun. 16, 2005

(54) Walking rope

(76) Inventor: Cynthia Miller, Edison, NJ (US)

Correspondence Address: KAPLAN & GILMAN , L.L.P., 900 ROUTE 9 NORTH, WOODBRIDGE, NJ, 07095, US

(21) Appl. No.: 11/008,397

(22) Filed: Dec. 9, 2004

Related U.S. Application Data
(60) Provisional application No. 60/529,878, filed on Dec. 16, 2003.

(51) Int. Cl. F16G 11/00; A44B 11/25; A44B 1/04; A44B 17/00; A63B 5/20

(52) U.S. Cl. 482/82

(57) ABSTRACT

A walking rope comprising a length of rope, cable, chain or the like comprising a plurality of loops, handles or other holdable extensions extending therefrom, said loops spaced from each other in varying distances. In one embodiment the invention comprises indicia holders such as but not limited to clear interchangeable tag holders disposed near at least one of, but preferably near each of, the loops.

### CROSS REFERENCE TO RELATED APPLICATIONS

This application claims the benefit of U.S. Provisional Patent Application No. 60/529,878, entitled “Walking Rope,” filed Dec. 16, 2003; the entire disclosure of which is hereby incorporated by reference.

### TECHNICAL FIELD

The invention relates to ropes and in particular ropes adapted to train and keep track of individuals.

### BACKGROUND OF THE INVENTION

Plain jump ropes have been used for years to walk children such as for instance when children are moving from class to class, at field trips and the like. However, plain jump ropes do not address the issue of having children stay in their correct place on the rope, i.e., maintaining the proper distance from another child and staying in the position they were put in on the rope for purposes of making the task of accounting for all children easier for the teacher, parent or other person(s) supervising the children.

### SUMMARY OF THE INVENTION

The present invention solves the aforementioned problems by providing each individual such as a student, special needs individual or the like a specific place on the rope and further provides the ability to employ indicia for identifying a child and/or the child's position on the rope. With the present invention there is no question as to where the individuals are to stay on the rope. The present invention comprises a walking rope comprising a length of rope, cable, chain or the like comprising a plurality of loops, handles or other holdable extensions extending therefrom, said loops spaced from each other in varying distances. In one embodiment the invention comprises indicia holders such as but not limited to clear interchangeable tag holders disposed near at least one of, but preferably near each of, the loops.

The invention is useful in many settings including but not limited to daycare centers and any other private or public institutions. It is designed to teach safe and structured transitions in schools, class trips or any type of group walking. It can also be used for young children or special needs children. The present invention also provides a tool for training children as to what is the proper distance to maintain from others so as to preserve each individual's personal space.

The present invention is also usable as a walking rope for teaching children to walk in a straight line. These and other aspects of the present invention will be apparent to those having skill in the art.

### BRIEF DESCRIPTION OF THE DRAWINGS

FIG. 1 is a perspective view of an embodiment of a device in accordance with the teachings of the present invention.

FIG. 2 is a perspective view of an embodiment of a device in accordance with the teachings of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in one embodiment” in various places in the specification are not necessarily all referring to the same embodiment.

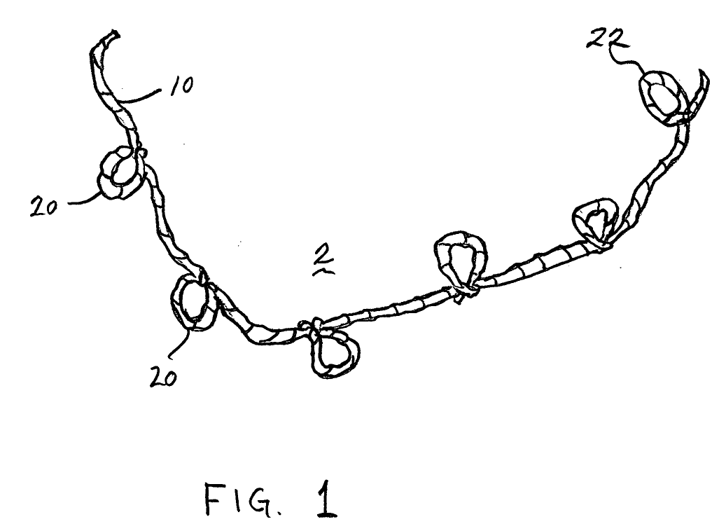

Now referring to FIG. 1, a device 2 in accordance with the present invention comprises a rope 10 comprising a plurality of holdable extensions 20 extending therefrom, said holdable extensions 20 spaced from each other in varying distances.

Rope 10 comprises any material such as rope, cable, chain or the like suitable for the purposes of the present invention. Suitable materials include but are not limited to nylon, hemp, cotton and the like; macrame rope; leather; cable; chain or the like. Various colors may be employed. The rope 10 is preferably light enough to prevent users from becoming fatigued but strong enough to avoid breakage, and of a material that will be comfortable in the hand of a user. The rope 10 is preferably a durable material such as nylon that will resist deterioration during storage.

Holdable extensions 20 comprise loops, handles or other means for a user to hold the rope 10.

In a preferred embodiment the device 2 employs holdable extensions 20 comprising a plurality of loops that are spaced apart from each other, to provide adequate personal space for each individual on the rope 10. The loops may be set having uniform intervals between loops, such as but not limited to 16″ spaces between each, or varying distances. A leading loop 22 and/or trailing loop (not shown) may be provided for teachers or chaperones, and these may be set at longer distances form the next loop, to provide more space for the larger adult.

The holdable extensions 20 alternatively comprise handles or other suitable holdable extensions. In another embodiment the holdable extensions 20 are adjustable along the length of the rope 10. Alternatively the holdable extensions 20 are removable. Removability may be achieved by having the extensions 20 attached to the rope 10 by snaps, hooks, Velcro, etc. Alternatively, metal rings are incorporated into the length of the rope 10 at specified distances to provide attachment devices to which the extensions 20 are fastened by any fastening means suitable for the purpose. Adjustability may be achieved by providing each extension 20 to be attached to said rope 10 a sleeve in which said rope 10 is slidably engaged. The sleeve of each extension 20, in the form of, for example, a handle or loop, can be tightened and fixed to said rope 10 at a desired location using a set screw, clamp or other suitable device known in the art.

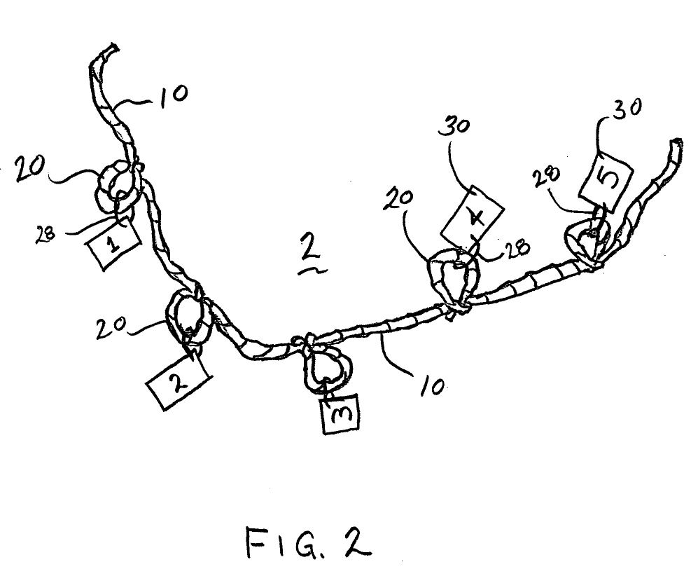

Now referring to FIG. 2, in another embodiment, means 28 for attaching indicia to each extension 20 are provided. Means 28 for attaching indicia may include clips, snaps or the like which may be attached to for example clear tag holders, toys, plush toys or the like. In a most preferred embodiment a device in accordance with the present invention further comprises indicia holders 30 such as but not limited to clear interchangeable tag holders disposed near at least one of, but preferably near each of, the extensions 20.

Tag holders are capable of receiving sheets such as paper, cardboard, felt or the like and used in the interchangeable clear tags. The tags may include indicia such as numbers, colors, days of the week, months of the year, animals, toys, food items and other various learning items. Sheets bearing multiple indicia that may be cut into individual tags may be provided in a system comprising the rope 10 of the present invention. The tags are helpful in identifying the particular extension 20 with which an individual child is associated.

In a most preferred embodiment a device 2 in accordance with the present invention comprises a rope 10 fabricated of macrame with extensions 20 comprising loops spaced at 16″ intervals. The device preferably comprises 6 to 8 hand held loops but a greater or lesser number may be provided depending on class or group size. The length of rope 10 varies depending on the needs of the group using the device 2.

Alternatively, the invention is provided as a set of ropes 10, each rope 10 having extensions 20 set at different intervals.

While the preferred embodiments have been described and illustrated it will be understood that changes in details and obvious undisclosed variations might be made without departing from the spirit and principle of the invention and therefore the scope of the invention is not to be construed as limited to the preferred embodiment.

1. A length of flexible material comprising at least two extensions extending therefrom, said extensions adapted to be capable of grasping by at least one individual.

2. The invention according to claim 1 said flexible material comprising a rope.

3. The invention according to claim 1 at least one of said extensions comprising a loop of flexible material.

4. The invention according to claim 1 at least one of said extensions comprising a handle.

5. The invention according to claim 2 at least one of said extensions comprising a loop of rope.

6. The invention according to claim 1 further comprising a means for attaching indicia.

7. The invention according to claim 1 further comprising an indicia holder.

8. The invention according to claim 7 said indicia holder extending from at least one of said extensions.

9. The invention according to claim 1 comprising at least 3 extensions.

10. The invention according to claim 1 said flexible material having a length of at least 36 inches.

11. The invention according to claim 1 wherein at least 8 inches separate said extensions.

12. A device comprising a rope having a plurality of holdable extensions extending therefrom.

13. A device according to claim 12 said rope comprising material selected from a group comprising macrame, hemp, cotton, nylon, rubber, plastic and yarn.

14. A device according to claim 12 comprising a means for attaching indicia.

15. A device according to claim 12 further comprising an indicia holder.

16. A device according to claim 15 said indicia holder extending from at least one of said extensions.

17. A device according to claim 14 said indicia selected from the group comprising tags, numbers, colors, days of the week, months of the year, animals, toys and food items.

18. A system comprising a plurality of ropes, each of said ropes comprising at least two holdable extensions extending therefrom.

19. The system according to claim 18 wherein at least one of said ropes has a length different than at least one other of said ropes.

20. The system according to claim 18 said ropes further comprising indicia extending therefrom.
